(19) United States
(12) Patent Application Publication
(10) Pub. No.: US 2006/0043948 A1
(43) Pub. Date: Mar. 2, 2006

(54) Load transient frequency modulation in fixed frequency PWM regulator

(76) Inventors: Xuening Li, Cary, NC (US); Stefan W. Wiktor, Raleigh, NC (US)

Correspondence Address: TEXAS INSTRUMENTS INCORPORATED, P O BOX 655474, M/S 3999, DALLAS, TX, 75265, US

(21) Appl. No.: 10/930,449

(22) Filed: Aug. 30, 2004

(51) Int. Cl. G05F 1/40

(52) U.S. Cl. 323/282

(57) ABSTRACT

A regulator circuit to regulate a voltage for a load includes a sensing circuit to sense a charge in voltage for the load, a variable frequency circuit to output a signal having a frequency component; and a control circuit responsive to the sensing circuit to control the variable frequency circuit by changing the frequency component and the voltage.

### FIELD OF THE INVENTION

The present invention relates to regulator circuits including PWM regulator circuits.

### BACKGROUND OF THE INVENTION

FIG. 1 illustrates a regulator including fixed frequency PWM modulator 120 providing fixed frequency PWM pulses; a fixed frequency oscillator 110 is connect to modulator 120, the modulator 120 outputting a fixed frequency PWM signal to inductor 130.

The switching period or frequency of the oscillator 110 determines the time interval or frequency of the output pulses from the modulator 120. The modulator 120 is connected to inductor 130. The inductor 130 outputs a current to capacitor 140 and subsequently to load 160. The fixed frequency of fixed frequency oscillator 110 can be lowered and results in a longer period (delay between) of PWM pulses. This lowered fixed frequency results in larger output voltage variation across load 160 and capacitor 140.

During normal operation, the OpAmp 180 with Nmos device 190 establishes Vref voltage across Rfset resistor. Vref across Rfset develops reference current which is mirrored by current mirror 100 into the oscillator 110 and establishes the oscillator running frequency.

The load change sensing element 150 describes load step sensing circuit based on monitoring the converter's output voltage.

Replacing the fixed frequency oscillator 110 with another fixed frequency oscillator of higher frequency improves the voltage variation problem across load 160 since the PWM pulses are input to the inductor 130 at a higher rate. However, the higher frequency and/or converter loop bandwidth creates additional problems and drawbacks which reduce the regulators efficiency over the steady state.

Consequently no suitable solution as to the proper choice of frequency has been found.

### SUMMARY OF THE INVENTION

The present invention provides a regulator circuit which increases the frequency of the oscillator due to the load step event for as long as the voltage step and slew rate detector senses the transient state. After that the regulation circuit reduces the frequency of the oscillator to the original or steady state.

Additionally, the present invention correlates the predetermined time when the frequency is increased to when the load is sensed.

This provides for increased response time and reduces the converter's output filter capacitance.

### BRIEF DESCRIPTION OF THE DRAWINGS

FIG. 1 illustrates a PWM rectifier with load modulating circuit;

FIG. 2 illustrates a PWM rectifier of the present invention;

FIG. 3 illustrates a graph of the defined load step region;

FIG. 4 illustrates a voltage step and slew rate detection circuit;

FIG. 5 illustrates the control circuit as applied to a multiphase regulator;

FIG. 6 illustrates an output signal of the present invention;

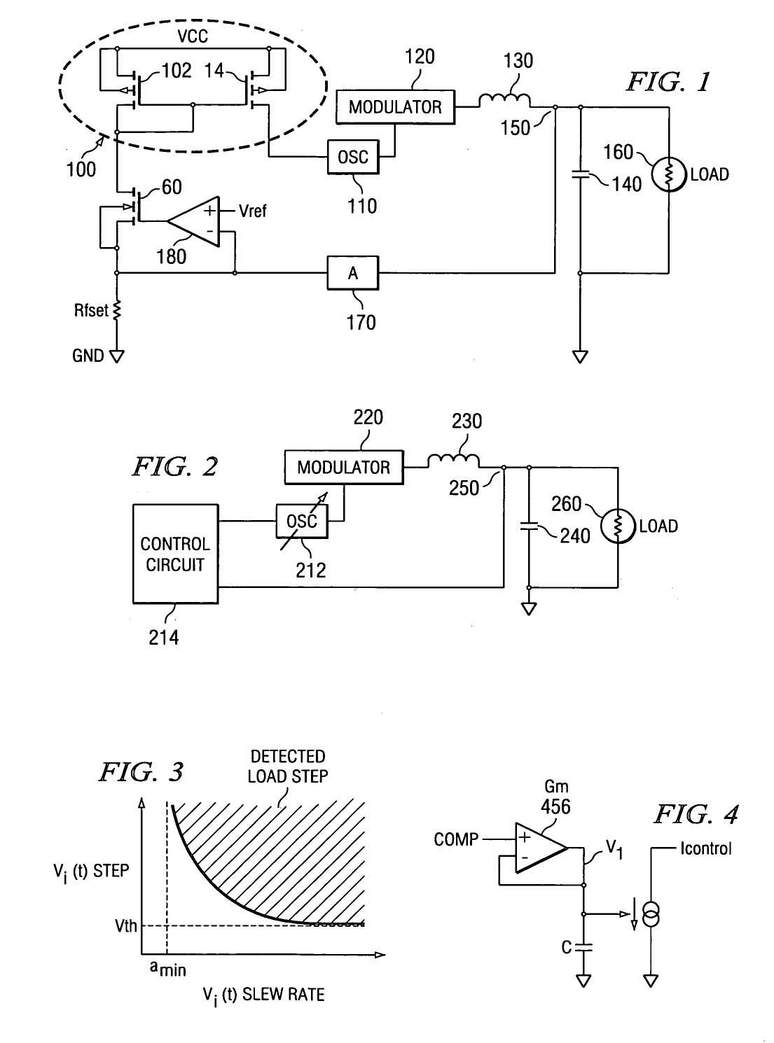

### DETAILED DESCRIPTION OF THE DRAWINGS

Turning now to FIG. 2, FIG. 2 illustrates a regulator circuit of the present invention including a control circuit 214 connected to a variable frequency oscillator 212. The variable oscillator 212 outputs a variable frequency signal, for example, such as a sine wave of variable frequency, to modulator 220 in accordance with a control signal output from control circuit 214. The control signal controls the frequency signal output from variable oscillator 212 namely the variable frequency signal. The modulator 220 outputs a pulse width modulated (PWM) signal having a frequency which corresponds to the output of the variable oscillator 212, namely the variable frequency signal and correspondingly varies in frequency in accordance with the control signal output from the control circuit 214. Thus it varies in frequency with respect to time the PWM signal in accordance with the control signal.

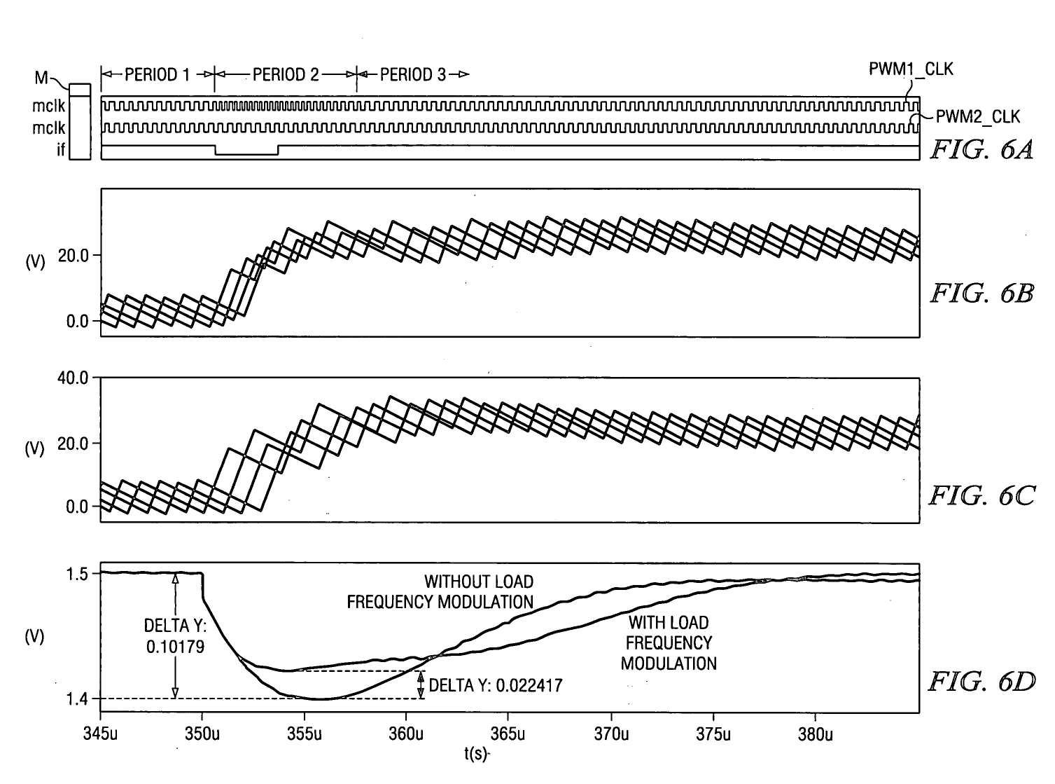

FIG. 6A illustrates the conventional PWM signal which remains constant in frequency throughout the entire operating period including periods of load variations and is shown in FIG. 6A as the PWM1 signal.

As shown in FIG. 6A, PWM1 remains constant through periods 1-3.

In contrast, the present invention generates a variable frequency PWM signal defined by PWM2, again illustrated in FIG. 6B, which is at a first frequency during period 1 and changes to a higher frequency in accordance with sensing a change in load during period 2. During period 2, a change in load is sensed by the sense element 250. The load change sensed by the sense element 250 by a change in voltage and this voltage change is detected by control circuit 214. The control circuit 214 changes the control signal to increase the frequency of variable frequency oscillator 212. The modulator 220 increases the frequency of the PWM signal in response to the increase in frequency of the output signal of the variable frequency oscillator 212. During period 3, the voltage across load 260 has recovered and the PWM signal returns to the frequency during period 1. Thus, as the signal from the control circuit 214 decreases, the frequency of the output signal the PWM signal from modulator 220 decreases. The relationship between the signal output from the control circuit 214 and the output signal from the modulator 222 does not need to be directly related; it could even be related as a square, inverse, or other relationship.

Thus, turning back to FIG. 2, when a voltage across load 260 and capacitor is 240 reduced for example, due to a change in load, the sense element 250 senses the lower voltage and outputs a signal to control circuit 214. Control circuit 214 responds by sending a control signal to variable oscillator 212 to increase the frequency of the output signal, which in turn increases the output of the PWM signal output from modulator 220.

There are many different circuits to sense the load transition from a first load level to a second load level and modulate the switching frequency. During the load transition and a corresponding current increase, the load voltage drops instantly due to ESR “equivalent series resistance” of the output capacitor 240. There are at least two ways to measure the load transition; one is to sense the output voltage of an error amplifier, or another is to sense the inductor current. Using the output voltage of the error amplifier has a faster response to load change then using the inductor current.

To determine the load step, both the voltage step and voltage slew rate are sensed and compared with their respective thresholds. The slew rate threshold being a_{MIN}, and the Vᵢₙ being the voltage step threshold.

FIG. 3 shows the detected load step region in which both the voltage step and voltage slew rate are larger than their respective threshold.

FIG. 3 additionally shows the slew rate, the Vᵢ(t) on the horizontal axes and the voltage step rate shown on the vertical axes as Vᵢ(t).

FIG. 4 illustrates a voltage step and slew rate detection circuit 256. This voltage step and slew rate detection circuit 256 can be used as a sensing circuit 214 as shown in FIG. 2.

As illustrated in FIG. 4, a transconductance amplifier (Gm) 456 outputs a current proportional to the difference between the voltage (V1) on capacitor C and the output voltage of the error amplifier (COMP). In steady state conditions voltage V1 and COMP are equal thus the capacitor current is zero. During a load step event the COMP voltage will no longer be equal to V1 thus generating current Icontrol. The Icontrol current is then applied to modulate the oscillator frequency 212 as described in FIG. 2.

FIGS. 6B and D illustrates the effect of the present invention.

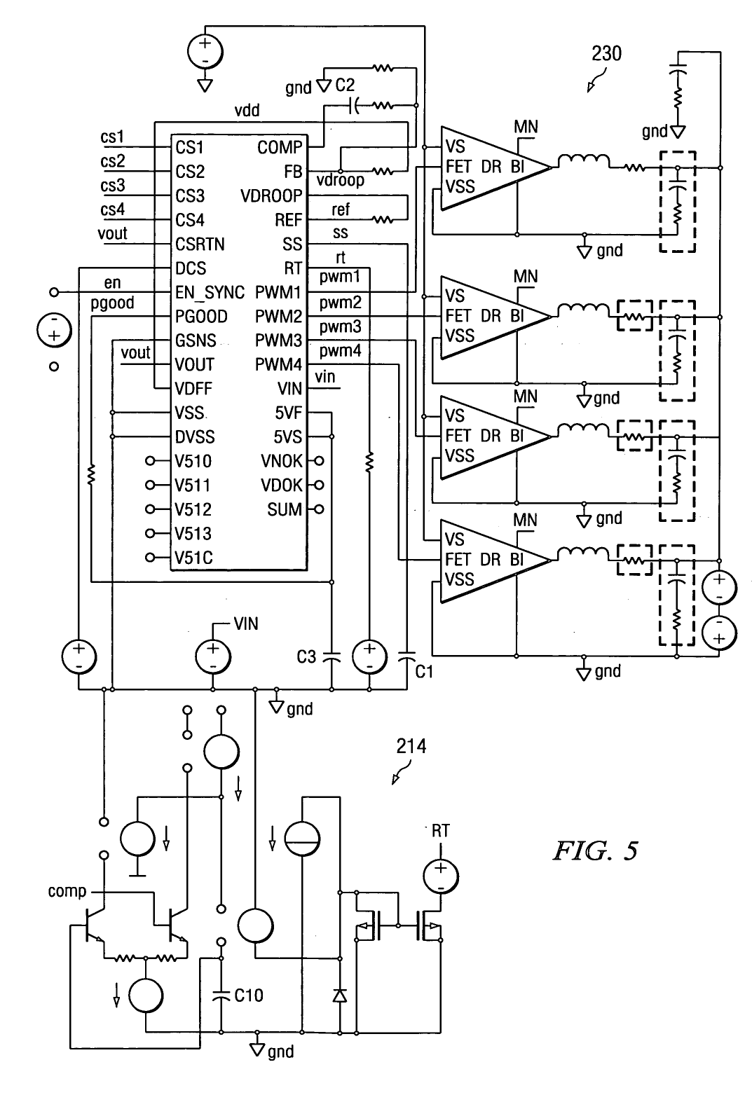

FIG. 6B illustrates the present invention while FIG. 6C illustrates the prior art. Both FIGS. 6B and 6C shows four phases of the circuit of FIG. 5. As FIG. 6B illustrates there are increase in numbers of cycles where energy is applied to inductor 130.

FIG. 5 illustrates a four phase circuit of the present invention using tps40090_A TI controller.

1. A regulator circuit to regulate a voltage for a load, comprising:
a sensing circuit to sense a charge in voltage for said load,
a variable frequency circuit to output a signal having a frequency component; and
a control circuit responsive to said sensing circuit to control said variable frequency circuit by changing said frequency component and the voltage.

2. A regulator circuit to regulate the voltage for the load as in claim 1, wherein said variable frequency circuit includes a PWM circuit.

3. A regulator circuit to regulate the voltage for the load as in claim 1, wherein said control circuit includes a current mirror.

4. A regulator circuit to regulate the voltage for the load as in claim 1, wherein said control circuit is controlled by a current.

5. A regulator circuit to regulate the voltage for the load as in claim 1, wherein said variable frequency circuit includes a variable frequency oscillator circuit.

6. A regulator circuit to regulate the voltage for the load as in claim 1, wherein said variable frequency circuit includes a modulator circuit.

7. A method to regulate a voltage for a load, comprising the steps of:
sensing a change in said voltage for the load;
outputting a voltage having a frequency component; and
controlling the voltage by changing the frequency component.

8. A regulator circuit to regulate the voltage for the load as in claim 7, wherein said step of controlling the voltage including the step of using a PWM circuit.

9. A regulator circuit to regulate the voltage for the load as in claim 7, wherein said step of controlling including the step of using a circuit mirror.

10. A regulator circuit to regulate the voltage for the load as in claim 7, wherein said step of controlling including the step of controlling a current.

11. A regulator circuit to regulate the voltage for the load as in claim 7, wherein said step of controlling the voltage including the step of using a modulator circuit.
